(19) United States
(12) Patent Application Publication
(10) Pub. No.: US 2015/0019395 A1
(43) Pub. Date: Jan. 15, 2015

(54) GEOGRAPHIC SCORE MODEL AND SERVICE

(71) Applicant: Lumesis, Inc., Stamford, CT (US)

(72) Inventors: Gregg L. Bienstock, Larchmont, NY (US); Timothy J. Stevens, Stamford, CT (US)

(21) Appl. No.: 14/329,106

(22) Filed: Jul. 11, 2014

Related U.S. Application Data
(60) Provisional application No. 61/845,204, filed on Jul. 11, 2013.

(51) Int. Cl. G06Q 40/00

(52) U.S. Cl. CPC G06Q 40/00
USPC 705/35

(57) ABSTRACT

Provides, relative to a bond, a relative point in time and trend score based on dispositive economic and demographic factors preferably for State, County and City/place geographies in which the score provides a relative “health” perspective as preferably the same factors relate to similar type of geographies. The data sets used in each geographical scoring are preferably consistent with one another.

### CROSS REFERENCE TO RELATED APPLICATIONS

This application claims priority to U.S. Patent Application Ser. No. 61/845,204 filed Jul. 11, 2013 which is incorporated herein by reference in its entirety.

### FIELD OF THE INVENTION

The invention relates to a computer implemented method and data processing system for use with financial instruments and tools, and more particularly, to a computer system and method for providing geographic scores based on economic and demographic data. The scores can be used in the financial services markets and more broadly in spaces where the economic well-being of a geographical place has relevance.

### BACKGROUND OF THE INVENTION

A problem associated with ratings, indices and other analytical tools servicing financial markets and other sectors concerned with or reliant on the economic well-being of geographies is the absence of unbiased, objective scores premised upon actual economic and demographic data that is relevant to the economic well-being of the geography being scored relative to like geographies (example: States relative to other States).

### SUMMARY OF THE INVENTION

The purpose and advantages of the below described illustrated embodiments will be set forth in and apparent from the description that follows. Additional advantages of the illustrated embodiments will be realized and attained by the devices, systems and methods particularly pointed out in the written description and claims hereof, as well as from the appended drawings.

To achieve these and other advantages and in accordance with the purpose of the illustrated embodiments, in one aspect, the present invention provides users a relative point in time and trend score based on dispositive economic and demographic factors preferably for State, County and City/place geographies in which the score provides a relative “health” perspective as preferably the same factors relate to similar type of geographies. It is noted the data sets used in each geographical scoring are preferably consistent with one another. Additionally, it is to be understood the score can be used within the financial services community, and more broadly by different industries and political institutions.

### BRIEF DESCRIPTION OF THE DRAWINGS

The objects and features of the invention can be understood with reference to the following detailed description of an illustrative embodiment of the present invention taken together in conjunction with the accompanying drawings in which:

FIG. 1 is a block diagram of a computer system that can be used with certain embodiments of the invention; and

FIG. 2 illustrates a hierarchy of certain economic and demographic factors that may drive a geographical score.

### DESCRIPTION OF EXAMPLE EMBODIMENTS

### Overview

According to one or more embodiments of the disclosure, described is a computer system and method that transforms individual factors (e.g., economic and demographic datasets) to a common metric and scope. This is preferably accomplished by standardizing the individual factors such that the mean equals zero and the standard deviation (e.g., a measure of how different of a particular location is from the average) is equal to 1. Utilizing this same scale, each individual factor measure is combined with their represented weights and summed, using an equal weighting for each factor) with one another to provide a final “composite” score of a particular geographic location (e.g., State, county, city or place). To de-emphasize the differences between individual county ranks, counties are preferably grouped into percentiles according to their economic climate outcomes, which subsequently can be presented/viewed as a scale alternative to displaying as an index score of 0 to 10.

### Description

The present invention is now described more fully below. The invention is not limited in any way to the description described below but is merely an overview description of the invention, which can be embodied in various forms, as appreciated by one skilled in the art. Therefore, it is to be understood that any structural and functional details disclosed herein are not to be interpreted as limiting the invention, but rather are provided as a representative embodiment for teaching one skilled in the art one or more ways to implement the invention. Furthermore, the terms and phrases used herein are not intended to be limiting, but rather are to provide an understandable description of the invention. Additionally like reference numerals are to be understood to refer to like elements.

This application is related to commonly assigned and co-pending U.S. patent application Ser. No. 13/046,405 (filed Mar. 11, 2011); Ser. No. 13/461,102 (filed May 2, 2011); Ser. No. 13/532,395 (Jun. 25, 2012) and Ser. No. 13/861,670 (filed Apr. 12, 2013), each of which is hereby incorporated by reference in its entirety.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, exemplary methods and materials are now described. All publications mentioned herein are incorporated herein by reference to disclose and describe the methods and/or materials in connection with which the publications are cited. For purposes of the below described invention, “DIVER Geo Score-Point in Time” is to be understood as reference to a relative score at a point in time of key indicators, including (but not limited to) Income, Housing and Unemployment & Employment rate so as to preferably be indicative of the current economic climate. And “DIVER Geo Score-Trend” is to be understood as reference to a relative score of annual change (date noted) of key indicators, including (but not limited to) changes of income, changes of housing and changes of unemployment & employment rate.

It must be noted that as used herein and in the appended claims, the singular forms “a”, “an,” and “the” include plural referents unless the context clearly dictates otherwise. Thus, for example, reference to “a stimulus” includes a plurality of such stimuli and reference to “the signal” includes reference to one or more signals and equivalents thereof known to those skilled in the art, and so forth.

It is to be appreciated that the embodiments of this invention as discussed below may be incorporated as a software algorithm, program or code residing in firmware and/or on computer useable medium (including software modules and browser plug-ins) having control logic for enabling execution on a computer system having a computer processor. Such a computer system typically includes memory storage configured to provide output from execution of the computer algorithm or program. As used herein, the term “software” is meant to be synonymous with any code or program that can be in a processor of a host computer, regardless of whether the implementation is in hardware, firmware or as a software computer product available on a disc, a memory storage device, or for download from a remote machine. The embodiments described herein include such software to implement the equations, relationships and algorithms described above. One skilled in the art will appreciate further features and advantages of the invention based on the above-described embodiments. Accordingly, the invention is not to be limited by what has been particularly shown and described, except as indicated by the appended claims. All publications and references cited herein are expressly incorporated herein by reference in their entirety.

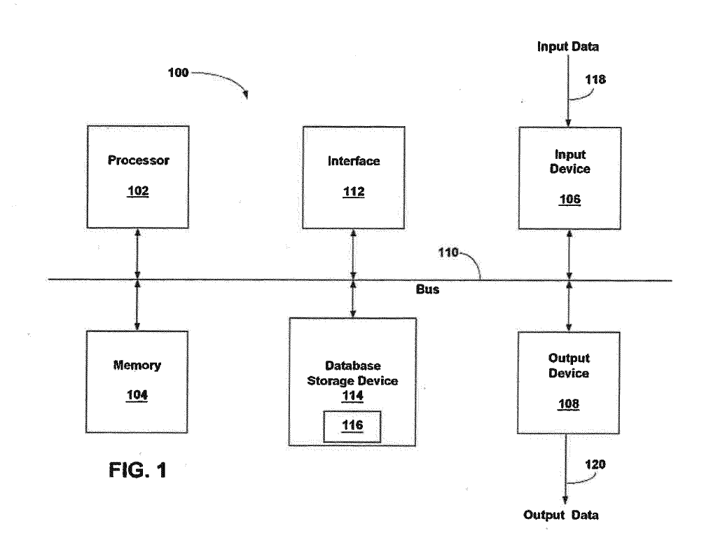

An exemplary computer system is shown as a block diagram in FIG. 1 depicting computer system 100. Although system 100 is represented herein as a standalone system, it is not limited to such, but instead can be coupled to other computer systems via a network (not shown) or encompass other embodiments as mentioned below. System 100 preferably includes a user interface 105, a processor 110 (such as a digital data processor), and a memory 115. Memory 115 is a memory for storing data and instructions suitable for controlling the operation of processor 110. An implementation of memory 115 can include a random access memory (RAM), a hard drive and a read only memory (ROM), or any of these components. One of the components stored in memory 115 is a program 120. Program 120 includes instructions for controlling processor 110. Program 120 may be implemented as a single module or as a plurality of modules that operate in cooperation with one another. Program 120 is contemplated as representing a software embodiment of the method 200 described herein below.

User interface 105 can include an input device, such as a keyboard, touch screen, tablet, API web services interface or speech recognition subsystem, for enabling a user to communicate information and command selections to processor 110. User interface 105 also includes an output device such as a display or a printer. In the case of a touch screen, the input and output functions are provided by the same structure. A cursor control such as a mouse, track-ball, or joy stick, allows the user to manipulate a cursor on the display for communicating additional information and command selections to processor 110. In contemplated alternative embodiments of the present invention, the program 120 can execute entirely without user input or other commands based on programmatic or automated access to a data signal flow through other systems that may or may not require a user interface for other reasons.

While program 120 is indicated as already loaded into memory 115, it may be configured on a storage media 125 for subsequent loading into memory 115. Storage media 125 can be any conventional storage media such as a magnetic tape, an optical storage media, a compact disc, a floppy disc, a silicon based memory storage device or the like. Alternatively, storage media 125 can be a random access memory, or other type of electronic storage, located on a remote storage system, such as a server that delivers the program 120 for installation and launch on a user device.

It is to be understood that the invention is not to be limited to such a computer system 100 as depicted in FIG. 1 but rather may be implemented on a general purpose microcomputer incorporating certain components of system 100, such as one of the members of the Sun® Microsystems family of computer systems, one of the members of the IBM® Personal Computer family, one of the members of the Apple® Computer family, or a myriad of other computer processor driven systems, including a: workstations, desktop computers, laptop computers, netbook computers, tablets (e.g., the Apple® IPAD®), a personal digital assistant (PDA), or a smart phone or other like handheld and/or portable devices.

FIG. 1 is intended to provide a brief, general description of an illustrative and/or suitable exemplary environment in which embodiments of the below described present invention may be implemented. FIG. 1 is an example of a suitable environment and is not intended to suggest any limitation as to the structure, scope of use, or functionality of an embodiment of the present invention. A particular environment should not be interpreted as having any dependency or requirement relating to any one or combination of components illustrated in an exemplary operating environment. For example, in certain instances, one or more elements of an environment may be deemed not necessary and omitted. In other instances, one or more other elements may be deemed necessary and added.

In the description that follows, certain embodiments may be described with reference to acts and symbolic representations of operations that are performed by one or more computing devices, such as the computing system environment 100 of FIG. 1. As such, it will be understood that such acts and operations, which are at times referred to as being computer-executed, include the manipulation by the processor of the computer of electrical signals representing data in a structured form. This manipulation transforms the data or maintains them at locations in the memory system of the computer, which reconfigures or otherwise alters the operation of the computer in a manner understood by those skilled in the art. The data structures in which data is maintained are physical locations of the memory that have particular properties defined by the format of the data. However, while an embodiment is being described in the foregoing context, it is not meant to be limiting as those of skill in the art will appreciate that the acts and operations described hereinafter may also be implemented in hardware.

Embodiments may be described in a general context of computer-executable instructions, such as program modules 120, being executed by a computer system 100. Generally, program modules 120 include routines, programs, objects, components, data structures, etc., that perform particular tasks or implement particular abstract data types. An embodiment may also be practiced in a distributed computing environment where tasks are performed by remote processing devices that are linked through a communications network. In a distributed computing environment, program modules 120 may be located in both local and remote computer storage media including memory storage devices.

With the exemplary computing system environment 100 of FIG. 1 being generally shown and discussed above, certain illustrative embodiments of the present invention will now be discussed. As mentioned above, an embodiment of the present invention transforms individual economic and demographic factors (e.g., economic datasets) relating to the economic well-being at a point in time or on a trend basis into a common metric and score. This is preferably accomplished by standardizing the individual factors such that the mean equals zero and the standard deviation (e.g., a measure of how different of a particular location is from the average) is equal to 1. Utilizing this same scale, each measure is combined with their represented weights (e.g., an equal weighting for each factor) and summed with one another to provide a final “composite” score of a particular geographic location (e.g., State, county, city or place).

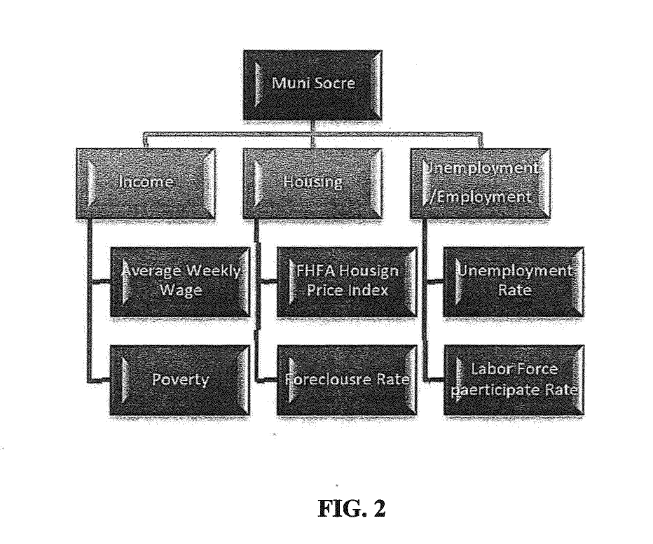

In accordance with an illustrated embodiment, economic/demographic factors include, but are not limited to: average weekly wages and poverty wherein it is to be understood poverty preferably removes the issue of outliers that average weekly wages has. For example, if 50% of a county is below the poverty line, but average weekly wages are high, it is evident that the pertinent geographic economy is not strong in the relevant county which implies there are instances of high outliers in average wages serving to bolster that value. Thus, this is an indication that the relevant county is not maximizing its income potential. Other economic/demographic factors include foreclosures (rate) and FHFA Price Index (Rate). It is noted that the FHFA Price Index can be viewed as either a positive or negative indicator, however, for illustrative purposes, it is viewed as a positive indicator herein. Additional economic/demographic factors include: unemployment (rate); labor force participation (rate) wherein it is to be understood labor force over population is an indication of how much of the population is actively looking for work in a given location. With reference to the FIG. 2, displayed is a hierarchy of certain factors relevant to the aforesaid economic/demographic factors

With reference now to the below illustrated exemplary scale, a given score for a particular geographic bond location is displayed on the MBR readily providing reference to a given location's economic health (e.g., the below scale indicates a score of 1.3 which is 8aa7% lower than the national average). It is to be appreciated that when a report is generated by system 100, a user can view this score on a scale, in addition to a number, thus providing a quick, visual representation of how the bond's location compares to others.

In accordance with an illustrated embodiment each of the following measurements: Standardizing Measures; Measures are in a number of different scales: Average Weekly Wages (Actual numerical numbers); Poverty (Percentage); Foreclosures Rate (Rate); FHFA Price Index (Rate); Unemployment rate (Rate); and Labor Force Participation Rate (Rate). Each are preferably transformed into a common metric preferably with an average value of 0 and a standard deviation (e.g., a measure of how different of a particular bond location from the average). By taking the standardized value of each factor for all locations, a “Z” Score is expressed via the equation:

$$Z = \frac{( Variable Value ) - ( Average of Variables for a selected factor )}{( Standard Deviation of variables for selected factor )}$$

wherein each Z-score is preferably relative to the other variables for a selected factor (and not compared to an absolute standard), preferably shown in the metric of standard deviations. For instance, a positive Z-score indicates a value higher than the average of variables value for a selected factor and a negative Z-score indicates a value for the selected factor lower than the average.

It is to be appreciated that for some of the measures, a higher Z-score score indicates a good economic situation (e.g., higher Average Weekly Wages). However, for other measures (e.g., unemployment rate) a higher score indicates poor economic situation or a less desirable value. Each aforesaid scenario is preferably taken into account before computing the DIVER Geo scores. Thus, the aforesaid scenarios, the Z-score is computed as above but is then multiplied by −1 such that higher scores indicate good health. It is noted that measures which are subject to this reverse coding (e.g., Z-score multiplied by −1) include: Unemployment; Poverty; Foreclosure; and Composite Scores.

It is to be further appreciated that the computed scores are preferably weighted composites of the Z-scores for individual measures where the weights represent relative importance of the different measures (e.g., a regression model/statistical analysis may be used for additional factors). A weighted composite is computed by multiplying each Z-score by its weight and adding them up by geographic locations (e.g., each city or place/county/state). The formula producing the weighted composite scores is:

Composite=ΣwᵢZᵢ

It is to be understood the Z, values are the Z-scores of the measures used to compute the summary score. The wᵢ values are the weights applied to each Z-score. As is typical, the Σ sign implies summing up all the Z-scores multiplied by their weights.

When using standardization, it is assumed that the data has been generated with a “Gaussian law” (the dataset has a certain average and standard deviation instead of totally random numbers), which may not always represent the actual scenario. However, for purposes of description of illustrated embodiments, no further assumed conclusions are made that depend on this distribution. It is also noted the entire population is used instead of a sample for each of the index whereby this assumption preferably does not affect the aforesaid data.

And with regards to ranking, after the composite scores are computed, they are preferably sorted from lowest to highest, such that all scores can be plotted on a scale from 0 to 10. For instance, the lowest ranked counties/states, cities and places have a score of 0, while the highest receive a score of 10.

With the illustrated embodiments being described above, optional embodiments of the present invention may also be said to broadly consist in the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth.

Although illustrated embodiments of the present invention has been described, it should be understood that various changes, substitutions, and alterations can be made by one of ordinary skill in the art without departing from the scope of the present invention.

What is claimed is:

1. A computer implemented method for determining a Z score for a financial bond, comprising:
acquiring, by a processor, a variable value (A) relating to the bond;
determining, by a processor, an average of variables (B) for a selected factor relating to the bond;
determining, by a processor, a standard deviation of variables for the selected factor (C); and
determining, by a processor, the Z score wherein
$$Z = \frac{( A ) - ( B )}{C}$$

2. The computer implemented method as recited in claim 1, wherein a positive Z score indicates a value higher than the average of variables for a selected factor (B).

3. The computer implemented method as recited in claim 1, wherein a negative Z score indicates a value lower than the average of variables for a selected factor (B).

4. The computer implemented method as recited in claim 1, further including the step of:
determining a weighted composite value (W) for each Z score for a selected factor
wherein W=ΣwᵢZᵢ, whereby wᵢ are weight values applied to each Z score
and Zᵢ are the Z scores of the measures used to compute a summary score.

5. The computer implemented method as recited in claim 1, wherein the selected factors are chosen from the group consisting of: income; housing; average weekly wage; FHFA Housing Price Index; unemployment rate; poverty; foreclosure rate; and labor force participant rate.

6. A computer system for determining a Z score for a financial bond, comprising:
a memory configured to store instructions;
a processor disposed in communication with said memory, wherein said processor upon execution of the instructions is configured to:
acquire a variable value (A) relating to the bond;
determine an average of variables (B) for a selected factor relating to the bond;
determine a standard deviation of variables for the selected factor (C); and
determine the Z score wherein
$$Z = \frac{( A ) - ( B )}{C}$$

7. The computer system as recited in claim 6, wherein a positive Z score indicates a value higher than the average of variables for a selected factor (B).

8. The computer system as recited in claim 6, wherein a negative Z score indicates a value lower than the average of variables for a selected factor (B).

9. The computer system as recited in claim 6, further including the step of:
determining a weighted composite value (W) for each Z score for a selected factor
wherein W=ΣwᵢZᵢ, whereby wᵢ are weight values applied to each Z score
and Zᵢ are the Z scores of the measures used to compute a summary score.

10. The computer system as recited in claim 6, wherein the selected factors are chosen from the group consisting of: income; housing; average weekly wage; FHFA Housing Price Index; unemployment rate; poverty; foreclosure rate; and labor force participant rate.

11. A non-transitory computer readable storage medium and one or more computer programs embedded therein, the computer programs comprising instructions, which when executed by a computer system, cause the computer system to:
acquire a variable value (A) relating to the bond;
determine an average of variables (B) for a selected factor relating to the bond;
determine a standard deviation of variables for the selected factor (C); and
determine the Z score wherein
$$Z = \frac{( A ) - ( B )}{C}$$

12. The non-transitory computer readable storage medium and one or more computer programs embedded therein as recited in claim 11, wherein a positive Z score indicates a value higher than the average of variables for a selected factor (B).

13. The non-transitory computer readable storage medium and one or more computer programs embedded therein as recited in claim 11, wherein a negative Z score indicates a value lower than the average of variables for a selected factor (B).

14. The non-transitory computer readable storage medium and one or more computer programs embedded therein as recited in claim 11, further including the step of:
determining a weighted composite value (W) for each Z score for a selected factor
wherein W=ΣwᵢZᵢ, whereby wᵢ are weight values applied to each Z score
and Zᵢ are the Z scores of the measures used to compute a summary score.

15. The non-transitory computer readable storage medium and one or more computer programs embedded therein as recited in claim 11, wherein the selected factors are chosen from the group consisting of: income; housing; average weekly wage; FHFA Housing Price Index; unemployment rate; poverty; foreclosure rate; and labor force participant rate.
